(19) United States
(12) Patent Application Publication
(10) Pub. No.: US 2026/0050472 A1
(43) Pub. Date: Feb. 19, 2026

(54) RESOURCE ALLOCATION AND MANAGEMENT IN BLOCKCHAIN SYSTEMS

(71) Applicant: CIRCLE INTERNET GROUP, INC., Boston, MA (US)

(72) Inventors: Li LI, San Bruno, CA (US); Benjamin SCHREFF, Charleston, SC (US); Xin JIN, London (GB); Viachaslau HAUMANAU, London (GB); Michelle RAN, Redondo Beach, CA (US); Adam Gregory ZION, Orinda, CA (US)

(21) Appl. No.: 18/808,812

(22) Filed: Aug. 19, 2024

(51) Int. Cl. G06F 9/50

(52) U.S. Cl. CPC G06F 9/5005; G06F 2209/5011

(57) ABSTRACT

Certain embodiments of the present disclosure provide techniques for allocating resources associated with tokens on a blockchain across resource providers in a distributed computing environment. An example method generally includes partitioning a total resource pool into a plurality of resource pools. Generally, each respective resource pool of the plurality of resource pools is associated with a respective resource provider. For each respective resource pool of the plurality of resource pools, the respective resource pool is partitioned into a reserve pool and an active pool based on an on-blockchain transaction history associated with tokens backed by the total resource pool. Transactions associated with the tokens are processed using one or more resource pools from the plurality of resource pools.

### INTRODUCTION

Embodiments of the present disclosure relate to resource allocation in blockchain systems, and more specifically to distributing resources across resource providers based on transactions performed in a blockchain system.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Blockchains generally allow for transactions to be performed using a variety of tokens which can be minted in various manners. For some tokens, such as stablecoins or other tokens which have value derived from some other asset (e.g., fiat currency, real-world assets, etc. for asset-backed stablecoins, other digital tokens for algorithmic stablecoins, etc.), tokens may be minted when the other assets backing these tokens are deposited, created, or otherwise made available to back the value of these tokens. In another example, for tokens which exist independently of other assets, tokens may be minted in various manners, such as upon verifying transactions on the blockchain, on an arbitrary schedule, or the like. Regardless of how tokens are minted, transactions performed on the blockchain using these tokens may involve the transfer of those tokens and the usage of underlying assets backing these tokens across different resource providers.

Accordingly, techniques are needed to allow for distributing resources across different resource providers in blockchain systems.

### BRIEF SUMMARY

Certain embodiments provide a computer-implemented method for allocating resources associated with tokens on a blockchain across resource providers in a distributed computing environment. An example method generally includes partitioning a total resource pool into a plurality of resource pools. Generally, each respective resource pool of the plurality of resource pools is associated with a respective resource provider. For each respective resource pool of the plurality of resource pools, the respective resource pool is partitioned into a reserve pool and an active pool based on an on-blockchain transaction history associated with tokens backed by the total resource pool. Transactions associated with the tokens are processed using one or more resource pools from the plurality of resource pools.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain embodiments of the one or more embodiments and are therefore not to be considered limiting of the scope of this disclosure.

FIG. 1 depicts an example distributed computing environment in which resources associated with tokens used in transactions performed on a blockchain are allocated across resource providers in the distributed computing environment, according to embodiments of the present disclosure.

FIG. 2 illustrates example operations for allocating resources associated with tokens used in transactions performed on a blockchain across resource providers in a distributed computing environment, according to embodiments of the present disclosure.

FIG. 3 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. These transactions may be performed using a variety of tokens; a first party to a transaction may send a quantity of tokens to second party to the transaction, and in exchange, the second party to the transaction may send a digital and/or physical asset to the first party of the transaction. In these cryptocurrency systems, processed transactions may not be modified at a later date, thus providing an immutable ledger of the transactions performed using the cryptocurrency system.

Generally, tokens used in performing transactions on a blockchain need to exist on the blockchain before such transactions are performed. To generate tokens on the blockchain, a process also known as minting, a minting authority or other minting mechanism may be used to generate new tokens and distribute these tokens to one or more wallets on the blockchain based on a variety of triggering conditions. For example, for tokens backed by real-world assets, such tokens may be generated when a real-world asset is received by the minting authority. Tokens may not be generated until corresponding real-world assets are received by the minting authority, as doing so may diminish the value of the tokens due to an imbalance between extant tokens on the blockchain and the real-world assets backing the tokens on the blockchain. For other types of tokens, such tokens may be generated when a triggering event occurs; for example, tokens may be minted and rewarded to a user on the blockchain when the user performs a specified action, such as the verification of other transactions on the blockchain.

During any time period, tokens may be created or destroyed. Generally, the creation of tokens (e.g., token minting operations) may result in the corresponding contribution of resources to a set of resources backing these tokens, while the destruction of tokens (e.g., token burning operations) may result in the corresponding removal of resources from the set of resources backing these tokens. The resources backing tokens used in transactions recorded on a blockchain may be distributed across a plurality of resource providers. For example, for tokens backed by real-world assets, the real-world assets (e.g., currency, cash equivalents, etc.) may be deposited at a plurality of institutions, each of which may have different resource availability and/or safety profiles. While the distribution of resources backing tokens across different resource providers may mitigate risks presented from relying on a single resource provider to provide sufficiently available resources for minting and burning operations, the distribution of resources may impose various bottlenecks on the completion of transactions performed using these tokens. For example, in a system in which resources are distributed across different resource pools on a geographic basis, it is possible for the resources to become depleted at a resource provider that handles transactions from a specific geographic area. Until resources become available at that resource provider (e.g., via a transfer of assets from another resource provider, freeing of assets at that resource provider, creation of assets at that resource provider, etc.), transactions may remain in a pending state. Thus, resource unavailability may increase the latency involved in processing transactions in a blockchain system, waste processing resources dedicated to processing these transactions, impose additional memory usage constraints on systems used to process transactions on the blockchain, and the like.

Embodiments of the present disclosure provide techniques for dynamically allocating and reallocating resources across different resource providers providing resources associated with tokens used in transactions on a blockchain. As discussed in further detail herein, resource providers may be allocated different portions of a total resource pool for use in processing transactions performed on the blockchain, and each resource provider may have its allocated resources divided into a reserve pool and an active pool. Transactions performed on the blockchain may be performed using resources from the active pool for one or more resource providers, and resources can be moved on an as-needed basis from the reserve pool to the active pool to allow for transactions to be performed without waiting for resources to become available at the one or more resource providers serving these transactions. Further, as resources are added and removed from the resource pool associated with a resource provider, resources can be reallocated across the universe of resource providers to minimize, or at least reduce, resource availability risks arising from concentrating resources at a resource provider while maximizing, or at least increasing, the likelihood that resources will be available to allow for real-time (or at least near-real-time) processing of transactions performed on the blockchain. Thus, embodiments of the present disclosure may increase the reliability and speed at which transactions are performed in blockchain systems, with corresponding reductions in wasted computing resources resulting from resource unavailability.

### Example Distribution and Allocation of Blockchain Token Resources Across Resource Pools in Distributed Computing Environments

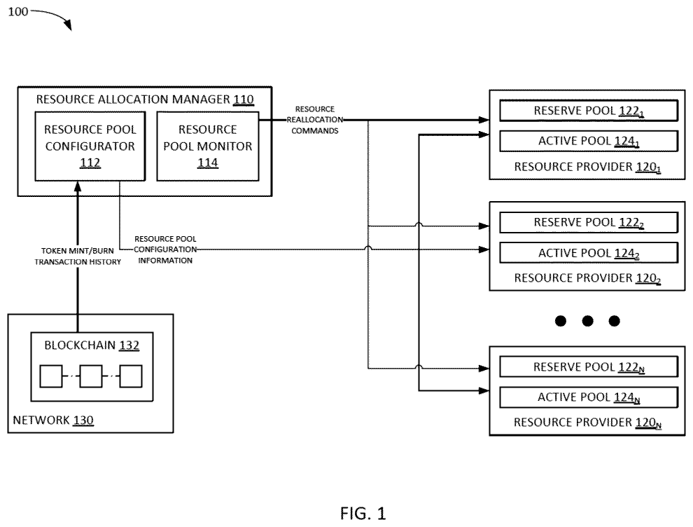

FIG. 1 illustrates an example distributed computing environment 100 in which resources associated with tokens used in transactions performed on a blockchain are distributed across resource providers, according to embodiments of the present disclosure. As illustrated, the distributed computing environment 100 includes a resource allocation manager 110, one or more resource providers 120₁-120_{N} (collectively referred to as a resource provider 120), and a network 130.

The resource allocation manager 110 generally represents a computing resource which manages the allocation of resources associated with tokens used in transactions performed on a blockchain across a plurality of resource providers 120 to minimize, or at least reduce, resource availability risks arising from concentrating resources at a resource provider and maximize, or at least increase, resource availability for transactions performed on a blockchain (e.g., the blockchain 132 illustrated in FIG. 1). For example, the resource allocation manager 110 may be hosted on a server computer, a cloud computing instance, or other computing system which can monitor transactions performed on the blockchain 132 and resource availability at the resource providers 120 and allocate and re-allocate resources across the resource providers 120 based on the monitoring. As illustrated, the resource allocation manager 110 includes a resource pool configurator 112 and a resource pool monitor 114.

Generally, the resource pool configurator 112 uses transaction history information from the blockchain 132 and information about the various resource providers 120 in the distributed computing environment 100 to configure the resource pools made available by the resource providers 120 for performing transaction on the blockchain 132. The resources provided by these resource providers 120 may include, for example, computing resources, asset management for resources backing the value of tokens used in transactions performed on the blockchain 132, or the like. Generally, a total resource pool based on which resources are distributed across the different resource providers 120 in the distributed computing environment 100 may be the sum of the resources available at each of the resource providers 120. For example, the total resource pool may be the total amount of resources associated with tokens used in transactions performed on the blockchain 132.

Generally, information about the various resource providers 120 may include various metrics related to resource availability risk at each of the various resource providers 120. For example, to maintain a level of service availability across resource providers 120 in the distributed computing environment 100, maximum resource pool sizes may be established to minimize the likelihood that resources will be unavailable to process transactions on the blockchain 132. In some embodiments, the information about the various resource providers 120 may include information about an amount of time each resource provider 120 would use in transferring resources to other resource providers 120 in the distributed computing environment, geographic regions from which transactions can be processed by each of the resource providers 120, and the like.

Resource configuration (e.g., initial allocation) for each resource provider 120 may be determined over a time window of any granularity. Smaller granularities may allow for resource configurations to be identified on a more granular level, while larger granularities may reduce the periodicity at which resources are reallocated across different resource providers 120 in the distributed computing environment 100. For example, the granularity over which a resource configuration may be determined may be a number of days, a number of weeks, or the like. In one example, different resource configurations may be identified for different groups of time periods. For example, a first resource configuration may be identified for business days, a second resource configuration may be identified for weekends or bank holidays, a third resource configuration may be identified for periods leading to the end of a defined period (e.g., quarter-end), and the like.

In some embodiments, to determine the resource configuration for each resource provider 120 and for a given period of time, the resource pool configurator 112 can retrieve token transaction history data from the blockchain 132 for processing. In one example, the token transaction history retrieved from the blockchain 132 may include token minting and token burning operations. By examining historical token minting and token burning operations, the resource pool configurator 112 can identify historical trends in net resource inflows and expenditures across different resource providers 120, different geographical regions, and the like. Transactions that do not involve the minting or burning of tokens on the blockchain may, in some cases, be disregarded, as these transactions may not implicate the creation or consumption of resources at a resource provider, but instead may represent a transfer of tokens from one party to another party on the blockchain for which a corresponding transfer of associated resources from one resource provider 120 to a different resource provider 120 is generally not executed.

Based on the historical token minting and token burning operations performed for a specific resource provider 120 or geographic region in which one or more resource providers 120 operate, the resource pool configurator 112 can determine the size of the reserve pool 122 and the active pool 124 for a resource provider 120 in the distributed computing environment 100. Generally, the reserve pool 122 may correspond to resources associated with tokens that need not be immediately available in order to support transactions on the blockchain 132 (e.g., need not be immediately available for distribution to a user when a token burning operation is performed). Meanwhile, the active pool 124 may correspond to resources that are immediately available in order to support transactions on the blockchain (e.g., to provide for the settlement of various transactions on the blockchain). Because transferring resources from a reserve pool 122 to an active pool 124 may have a computational cost (e.g., involve some amount of time for such resources to be transferred) and generate a risk of resource unavailability, the reserve pool 122 may be set with a minimum size that allows for some transfers of resources from the reserve pool 122 to the active pool 124 but maintains sufficient resources to guarantee that the resources associated with tokens on the blockchain exist and can be made available on demand (e.g., when tokens are burned, which generally triggers a release of the resources associated with the burned tokens to a destination account). Further, the reserve pool 122 may, in some embodiments, include an additional amount of resources over the minimum resource size to allow for resources to be made available in the active pool 124 (e.g., when the active pool 124 is depleted due to net outflows resulting from token burning operations on the blockchain 132) while minimizing, or at least reducing, the likelihood that any resource provider 120 in the distributed computing environment 100 is required to obtain resources from another resource provider 120 in order to satisfy a transaction. As discussed, by doing so, aspects of the present disclosure may reduce the amount of time used to perform transactions and may also minimize a likelihood of transactions timing out and being re-processed (and incurring additional processing overheads, in terms of processor time, bandwidth, and the like in re-processing such a transaction).

Generally, the resource pool configurator 112 can determine the size of the active pool 124 for a resource provider 120 based on the historical amounts of resources received or otherwise created in the distributed computing environment 100 when tokens are minted and the historical amounts of resources consumed or otherwise destroyed in the distributed computing environment 100 when tokens are burned. In some embodiments, the delta between the resources received from token minting operations and resources consumed in token burning operations may be used to determine the size of the active pool 124. For example, the amount of resources included in the active pool 124 may be based, for example, on an average amount of resources consumed over a given time window (e.g., a weekday time window, a weekend/bank holiday time window, an end-of-period time window, etc.). In cases in which the delta is positive, indicating that more resources are contributed to the resource provider 120 than are consumed by the resource provider 120 in satisfying token minting and burning transactions, the size of the active pool 124 may be set to an priori defined minimum amount of resources to account for activity that is an outlier compared to typical activity trends with respect to a resource provider 120. In cases in which the delta is negative, indicating that more resources are consumed by the resource provider 120 than are contributed to the resource provider 120 in satisfying token minting and burning transactions, the size of the active pool 124 may be set based on the average amount of resources consumed over a time window. In some embodiments, an additional buffer may be added to the size of the active pool 124 to account for activity that is an outlier compared to typical activity trends with respect to a resource provider 120.

After the resource pool configurator 112 determines the amount of resources to be allocated to each resource provider 120 and the amount of resources in the reserve pool 122 and the active pool 124 for each resource provider 120, the resource pool configurator 112 can output the configuration information to the resource providers. In some embodiments, the configuration information may include various commands to initiate transfers of resources between different resource providers 120. For example, if the amount of resources currently held, managed, or otherwise controlled by the resource provider 120₁ exceeds the maximum amount of resources allowed to be held, managed, or otherwise controlled by the resource provider 120₁, the configuration information may include one or more commands identifying amounts of resources to be transferred from the resource provider 120₁ to one or more of the other resource providers 120₂-120_{N} in the distributed computing environment 100. In another example, if the amount of resources currently held, managed, or otherwise controlled by the resource provider 120₁ is less than a minimum amount of resources that the resource provider 120₁ should hold, manage, or otherwise control, the configuration information may include one or more commands identifying amounts of resources to be requested for transfer from one or more of the other resource providers 120₂-120_{N} in the distributed computing environment 100.

In some embodiments, the resource pool configurator 112 can dynamically adjust the allocation of resources across different resource providers 120 and the allocation of resources between the reserve pool and the active pool at a resource provider 120. These adjustments may be performed, for example, as different time windows are reached. For example, resource allocations may be adjusted when a clock at the resource allocation manager 110 indicates that the current time has switched from being in a weekday time period to being in a weekend time period or a bank holiday time period, or vice versa.

After the resource pool configurator 112 determines the resource allocation across different resource providers 120, the resource pool monitor 114 can monitor and manage resource availability at the resource providers 120. In some embodiments, to do so, the resource pool monitor 114 can periodically query the resource providers 120 to determine whether the resource providers 120 are responsive to external requests. If a resource provider 120 fails to respond to external requests, the resources allocated to that resource provider can be temporarily excluded from the available resource pool, and the size of the active pool 124 at the other resource providers 120 can be modified to allow for available resource providers 120 to satisfy transactions on the blockchain 132.

In some embodiments, the resource pool monitor 114 can monitor the amount of resources held, managed, or otherwise controlled by a resource provider 120 to determine whether and how to reallocate resources across the resource providers 120₁-120_{N} in the distributed computing environment 100. For example, if the currently held, managed, or otherwise controlled by the resource provider 120₁ exceeds the maximum amount of resources allowed to be held, managed, or otherwise controlled by the resource provider 120₁, the resource pool monitor 114 can generate one or more resource reallocation commands instructing the resource provider 120₁ to transfer resources one or more of the other resource providers 120₂-120_{N} in the distributed computing environment 100. In another example, if the amount of resources currently held, managed, or otherwise controlled by the resource provider 120₁ is less than a minimum amount of resources that the resource provider 120₁ should hold, manage, or otherwise control, the resource pool monitor 114 can generate one or more resource reallocation commands instructing one or more of the other resource providers 120₂-120_{N} to transfer specified amounts of resources to the resource provider 120₁.

In some embodiments, the resource pool monitor 114 can monitor the size of the reserve pool 122 and the active pool 124 at each resource provider 120 to determine when to adjust the size of the reserve pool 122 and the active pool 124 at a resource provider 120. When excess resources are included in the active pool 124, the excess assets may be transferred to the reserve pool 122 via one or more reallocation commands transmitted to the resource provider 120 by the resource pool monitor 114. Similarly, when the amount of resources in the active pool 124 falls below a threshold amount, the resource pool monitor 114 can transmit one or more reallocation commands to the resource provider 120 to effectuate a transfer of resources from the reserve pool 122 to the active pool 124.

The network 130 may, in some embodiments, be a cryptocurrency network for which the resource allocation manager 110 manages resources associated with tokens used in performing various transactions on the network. By way of example, network 130 may be a network such as ALGORAND™, BITCOIN™, ETHEREUM®, SOLANA™, STELLAR™, TRON™, and other cryptocurrency networks. Transactions on a blockchain 132 hosted by network 140 may include, for example, the execution of one or more smart contracts on the blockchain 132 or by the generation of one or more blocks on the blockchain evidencing the occurrence of a transaction on the blockchain 132.

### Example Operations for Distributing and Allocating Blockchain Token Resources Across Resource Pools in Distributed Computing Environments

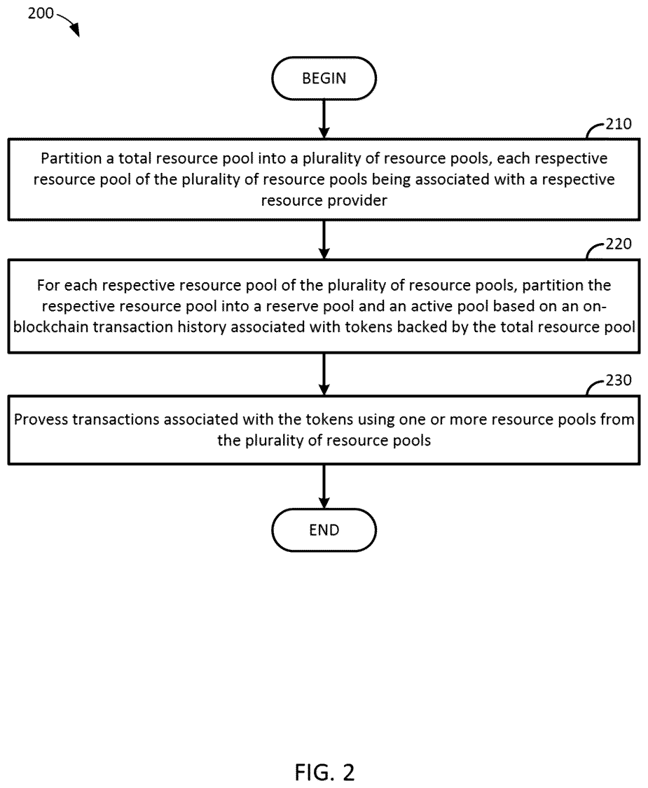

FIG. 2 illustrates example operations 200 for allocating resources associated with tokens used in transactions performed on a blockchain across resource providers in a distributed computing environment, according to embodiments of the present disclosure. The operations 200 may be performed, for example, by the resource allocation manager 110 illustrated in FIG. 1 or other computing devices which can monitor and manage resource allocation across different resource providers in the distributed computing environment.

As illustrated, the operations 200 begin at block 210 with partitioning a total resource pool into a plurality of resource pools. Generally, each respective resource pool of the plurality of resource pools may be associated with a respective resource provider.

In some embodiments, partitioning the total resource pool into the plurality of resource pools comprises allocating a portion of the total resource pool to a first resource pool associated with a first resource provider based on a maximum resource pool size associated with the first resource provider. The maximum resource pool size associated with the first resource provider may be set, for example, as a maximum proportion of the total resource pool which can be held, managed, or otherwise controlled by the first resource provider based on various risk and availability metrics associated with the first resource provider. For example, larger resource providers may be allowed to maintain a larger proportion of the resource pool than smaller resource providers. In another example, resource providers with higher uptime or reliability metrics may be allowed to maintain a larger proportion of the resource pool than resource providers with lower uptime or reliability metrics. It should be recognized that the foregoing are only examples of risk and availability metrics based on which resources can be allocated to resource pools associated with different resource providers, and other risk and/or availability metrics may be contemplated.

In some embodiments, partitioning the total resource pool into the plurality of resource pools is based on historical transaction volumes associated with different geographic regions in which the resource pools are distributed.

At block 220, the operations 200 proceed with partitioning, for each respective resource pool of the plurality of resource pools, the respective resource pool into a reserve pool and an active pool based on an on-blockchain transaction history associated with tokens backed by the total resource pool.

In some embodiments, partitioning the respective resource pool into the reserve pool and the active pool comprises determining a size of the active pool based on historical token minting activity and historical token burning activity in the on-blockchain transaction history. The historical token minting activity and historical token burning activity may include token minting and burning activity on previous time windows similar to a current time window. For example, the historical token minting activity and historical token burning activity may include activity performed during weekdays, during weekends, during bank holidays, during end-of-time-period time windows, or the like. In some embodiments, the size of the active pool is further based on a buffer amount defined for the respective resource pool.

At block 230, the operations 200 proceed with processing transactions associated with the tokens using one or more resource pools from the plurality of resource pools.

In some aspects, processing the transaction includes transferring resources from a reserve pool associated with the one or more resource pools to an active pool associated with the one or more resource pools when an amount of resources in the active pool associated with the one or more resource pools is less than an amount of resources specified in the transaction.

In some embodiments, the operations 200 further include determining that an amount of resources in the first resource pool exceed the maximum resource pool size associated with the first resource provider. Based on the determining, a size of the first resource pool and one or more second resource pools may be adjusted such that the amount of resources in the first resource pool does not exceed the maximum resource pool size associated with the first resource provider.

In some embodiments, the operations 200 further include determining that an amount of resources in the first resource pool is less than a minimum resource pool size associated with the first resource provider. Based on the determining, a size of the first resource pool and one or more second resource pools may be adjusted such that the amount of resources in the first resource pool exceeds the minimum resource pool size associated with the first resource provider. In some embodiments, the resources transferred from the one or more second resource pools to the first resource pool may include resources from at least one resource pool in a same geographic location as the first resource pool and having an amount of resources approaching a maximum resource pool size for the at least one resource pool. In some embodiments, the resources transferred from the one or more second resource pools to the first resource pool may include resources from at least one resource pool in a different geographic location as the first resource pool.

The resource reallocation operations across different resource providers may be performed at various times. In some embodiments, these resource reallocation operations may be performed at date changes to account for whether the resource providers are configured for weekday operations, weekend operations, bank holiday operations, end-of-time-period operations, or the like.

In some aspects, the operations further include identifying the plurality of resource pools based on responsiveness to status requests by resource providers in the distributed computing environment.

### Example System for Distributing and Allocating Blockchain Token Resources Across Resource Pools in Distributed Computing Environments

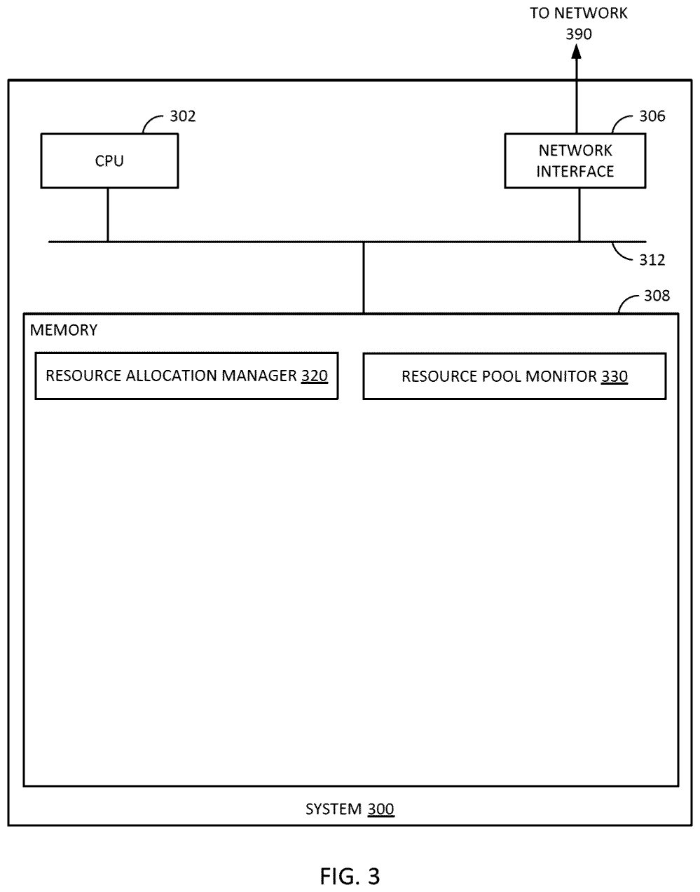

FIG. 3 illustrates an example system 300 configured to perform the methods described herein, including, for example, operations 200 illustrated in FIG. 2. In some embodiments, system 300 may act as a computing system implementing the resource allocation manager 110 illustrated in FIG. 1.

As shown, system 300 includes a central processing unit (CPU) 302, network interface 306 through which system 300 is connected to network 390 (which may be a local network, an intranet, the internet, or any other group of computing devices communicatively connected to each other), a memory 308, and an interconnect 312. The network interface 306 may be used to receive requests to upgrade bridged tokens on a blockchain to native tokens on the blockchain (e.g., as depicted and described with respect to FIGS. 1 through 4.

CPU 302 may retrieve and execute programming instructions stored in the memory 308. Similarly, the CPU 302 may retrieve and store application data residing in the memory 308. The interconnect 312 transmits programming instructions and application data, among the CPU 302, network interface 306, and memory 308.

CPU 302 is included to be representative of a single CPU, multiple CPUs, a single CPU having multiple processing cores, and the like.

Memory 308 is representative of a volatile memory, such as a random access memory, or a nonvolatile memory, such as nonvolatile random access memory, phase change random access memory, or the like. As shown, memory 308 includes a resource pool configurator 320 and a resource pool monitor 330

The resource pool configurator 320 generally corresponds to the resource pool configurator 112 illustrated in FIG. 1. Generally, the resource pool configurator 320 uses information associated with resource providers on the network 390 and transaction history retrieved from a blockchain (e.g., via the network interface 306) to determine how to allocate resources across different resource providers and how to allocate resources between a reserve pool and an active pool at each resource provider on the network 390. The transaction history retrieved from the blockchain may include token minting operations and token burning operations. The net delta between token minting and token burning operations being used to determine the size of the reserve pool and that active pool at each resource provider on the network 390.

The resource pool monitor 330 generally corresponds to the resource pool monitor 114 illustrated in FIG. 1. Generally, the resource pool monitor 330 monitors resource allocation and availability at each of the resource providers on the network 390 and the size of the reserve pool and active pool at each of the resource providers on the network 390 to determine when and how to reallocate resources across and within resource providers. When the resource pool monitor 330 determines that a resource provider has excess or too few resources, the resource pool monitor 330 can instruct the resource provider on the network 390 to transfer resources between each other until the resource providers comply with minimum and maximum resource allocation rules defined for the resource providers. When the resource pool monitor 330 determines that the amount of resources in an active pool at a resource provider exceeds a maximum size or is less than a minimum size, the resource pool monitor 330 can transfer resources from the reserve pool to the active pool at that resource provider.

### EXAMPLE CLAUSES

Implementation details for various embodiments of the present disclosure are described in the following numbered clauses.

### Clause 1

A processor-implemented method for managing resource allocation in a distributed computing environment, comprising: partitioning a total resource pool into a plurality of resource pools, each respective resource pool of the plurality of resource pools being associated with a respective resource provider; for each respective resource pool of the plurality of resource pools, partitioning the respective resource pool into a reserve pool and an active pool based on an on-blockchain transaction history associated with tokens backed by the total resource pool; and processing transactions associated with the tokens using one or more resource pools from the plurality of resource pools.

### Clause 2

The method of Clause 1, wherein partitioning the total resource pool into the plurality of resource pools comprises allocating a portion of the total resource pool to a first resource pool associated with a first resource provider based on a maximum resource pool size associated with the first resource provider.

### Clause 3

The method of Clause 2, further comprising: determining that an amount of resources in the first resource pool exceed the maximum resource pool size associated with the first resource provider; and based on the determining, adjusting a size of the first resource pool and one or more second resource pools such that the amount of resources in the first resource pool does not exceed the maximum resource pool size associated with the first resource provider.

### Clause 4

The method of any one of Clauses 2 or 3, further comprising: determining that an amount of resources in the first resource pool is less than a minimum resource pool size associated with the first resource provider; and based on the determining, adjusting a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a same geographic location as the first resource pool and having an amount of resources approaching a maximum resource pool size for the at least one resource pool.

### Clause 5

The method of any one of Clauses 2 through 4, further comprising: determining that an amount of resources in the first resource pool is less than a minimum resource pool associated with the first resource provider; and based on the determining, adjusting a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a different geographic location as the first resource pool and having an amount of resources approaching a maximum resource pool size for the at least one resource pool.

### Clause 6

The method of any one of Clauses 1 through 5, the partitioning the total resource pool into the plurality of resource pools is based on historical transaction volumes associated with different geographic regions in which the resource pools are distributed.

### Clause 7

The method of any one of Clauses 1 through 6, wherein partitioning the respective resource pool into the reserve pool and the active pool comprises determining a size of the active pool based on historical token minting activity and historical token burning activity in a transaction history associated with the on-blockchain transaction history.

### Clause 8

The method of Clause 7, wherein the historical token minting activity and historical token burning activity comprises token minting and burning activity on previous time windows similar to a current time window.

### Clause 9

The method of any one of Clauses 7 or 8, wherein the size of the active pool is further based on a buffer amount defined for the respective resource pool.

### Clause 10

The method of any one of Clauses 1 through 9, further comprising identifying the plurality of resource pools based on responsiveness to status requests by resource providers in the distributed computing environment.

### Clause 11

The method of any one of Clauses 1 through 10, wherein processing the transaction comprises transferring resources from a reserve pool associated with the one or more resource pools to an active pool associated with the one or more resource pools when an amount of resources in the active pool associated with the one or more resource pools is less than an amount of resources specified in the transaction.

### Clause 12

A system, comprising: a memory having executable instructions stored thereon; and a processor configured to execute the executable instructions to perform the operations of any one of Clauses 1 through 11.

### Clause 13

A system, comprising: means for performing the operations of any one of Clauses 1 through 11.

### Clause 14

A computer-readable medium having instructions stored thereon which, when executed by a processor, performs the operations of any one of Clauses 1 through 11.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the embodiments set forth herein. In addition, the scope of the disclosure is intended to cover such an apparatus or method that is practiced using other structure, functionality, or structure and functionality in addition to, or other than, the various embodiments of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for. ” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for managing resource allocation in a distributed computing environment, comprising:
partitioning a total resource pool into a plurality of resource pools, each respective resource pool of the plurality of resource pools being associated with a respective resource provider;
for each respective resource pool of the plurality of resource pools, partitioning the respective resource pool into a reserve pool and an active pool based on an on-blockchain transaction history associated with tokens backed by the total resource pool; and
processing transactions associated with the tokens using one or more resource pools from the plurality of resource pools.

2. The method of claim 1, wherein partitioning the total resource pool into the plurality of resource pools comprises allocating a portion of the total resource pool to a first resource pool associated with a first resource provider based on a maximum resource pool size associated with the first resource provider.

3. The method of claim 2, further comprising:
determining that an amount of resources in the first resource pool exceed the maximum resource pool size associated with the first resource provider; and
based on the determining, adjusting a size of the first resource pool and one or more second resource pools such that the amount of resources in the first resource pool does not exceed the maximum resource pool size associated with the first resource provider.

4. The method of claim 2, further comprising:
determining that an amount of resources in the first resource pool is less than a minimum resource pool size associated with the first resource provider; and
based on the determining, adjusting a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a same geographic location as the first resource pool and having an amount of resources approaching a maximum resource pool size for the at least one resource pool.

5. The method of claim 2, further comprising:
determining that an amount of resources in the first resource pool is less than a minimum resource pool associated with the first resource provider; and
based on the determining, adjusting a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a different geographic location as the first resource pool and having an amount of resources approaching a maximum resource pool size for the at least one resource pool.

6. The method of claim 1, wherein the partitioning the total resource pool into the plurality of resource pools is based on historical transaction volumes associated with different geographic regions in which the resource pools are distributed.

7. The method of claim 1, wherein partitioning the respective resource pool into the reserve pool and the active pool comprises determining a size of the active pool based on historical token minting activity and historical token burning activity in a transaction history associated with the on-blockchain transaction history.

8. The method of claim 7, wherein the historical token minting activity and historical token burning activity comprises token minting and burning activity on previous time windows similar to a current time window.

9. The method of claim 7, wherein the size of the active pool is further based on a buffer amount defined for the respective resource pool.

10. The method of claim 1, further comprising identifying the plurality of resource pools based on responsiveness to status requests by resource providers in the distributed computing environment.

11. The method of claim 1, wherein processing the transaction comprises transferring resources from a reserve pool associated with the one or more resource pools to an active pool associated with the one or more resource pools when an amount of resources in the active pool associated with the one or more resource pools is less than an amount of resources specified in the transaction.

12. A processing system for managing resource allocation in a distributed computing environment, comprising:
at least one memory having executable instructions stored thereon; and
one or more processors configured to execute the executable instructions to cause the processing system to:
partition a total resource pool into a plurality of resource pools, each respective resource pool of the plurality of resource pools being associated with a respective resource provider;
for each respective resource pool of the plurality of resource pools, partition the respective resource pool into a reserve pool and an active pool based on an on-blockchain transaction history associated with tokens backed by the total resource pool; and
process transactions associated with the tokens using one or more resource pools from the plurality of resource pools.

13. The processing system of claim 12, wherein to partition the total resource pool into the plurality of resource pools, the one or more processors are configured to cause the processing system to allocate a portion of the total resource pool to a first resource pool associated with a first resource provider based on a maximum resource pool size associated with the first resource provider.

14. The processing system of claim 13, wherein the one or more processors are further configured to cause the processing system to:
determine that an amount of resources in the first resource pool exceed the maximum resource pool size associated with the first resource provider; and
based on the determination, adjust a size of the first resource pool and one or more second resource pools such that the amount of resources in the first resource pool does not exceed the maximum resource pool size associated with the first resource provider.

15. The processing system of claim 13, wherein the one or more processors are further configured to cause the processing system to:
determine that an amount of resources in the first resource pool is less than a minimum resource pool size associated with the first resource provider; and
based on the determination, adjust a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a same geographic location as the first resource pool and having an amount of resources approaching a maximum resource pool size for the at least one resource pool.

16. The processing system of claim 13, wherein the one or more processors are further configured to cause the processing system to:
determine that an amount of resources in the first resource pool is less than a minimum resource pool associated with the first resource provider; and
based on the determination, adjust a size of the first resource pool and one or more second resource pools such that the amount of resources in the first resource pool exceeds the minimum resource pool size associated with the first resource provider, wherein resources transferred from the one or more second resource pools to the first resource pool comprise resources from at least one resource pool in a different geographic location as the first resource pool and having an amount of resources approaching a maximum resource pool size for the at least one resource pool.

17. The processing system of claim 12, wherein the one or more processors are configured to partition the total resource pool into the plurality of resource pools based on historical transaction volumes associated with different geographic regions in which the resource pools are distributed.

18. The processing system of claim 12, wherein to partition the respective resource pool into the reserve pool and the active pool, the one or more processors are configured to cause the processing system to determine a size of the active pool based on historical token minting activity and historical token burning activity in a transaction history associated with the on-blockchain transaction history.

19. The processing system of claim 18, wherein the historical token minting activity and historical token burning activity comprises token minting and burning activity on previous time windows similar to a current time window.

20. The processing system of claim 18, wherein the size of the active pool is further based on a buffer amount defined for the respective resource pool.

21. The processing system of claim 12, wherein the one or more processors are further configured to cause the processing system to identify the plurality of resource pools based on responsiveness to status requests by resource providers in the distributed computing environment.

22. The processing system of claim 12, wherein to process the transaction, the one or more processors are configured to cause the processing system to transfer resources from a reserve pool associated with the one or more resource pools to an active pool associated with the one or more resource pools when an amount of resources in the active pool associated with the one or more resource pools is less than an amount of resources specified in the transaction.

23. A non-transitory computer-readable medium having executable instructions stored thereon which, when executed by one or more processors, causes the one or more processors to perform an operation for managing resource allocation in a distributed computing environment, the operation comprising:
partitioning a total resource pool into a plurality of resource pools, each respective resource pool of the plurality of resource pools being associated with a respective resource provider;
for each respective resource pool of the plurality of resource pools, partitioning the respective resource pool into a reserve pool and an active pool based on an on-blockchain transaction history associated with tokens backed by the total resource pool; and
processing transactions associated with the tokens using one or more resource pools from the plurality of resource pools.
